(19) United States
(12) Patent Application Publication
(10) Pub. No.: US 2022/0061126 A1
(43) Pub. Date: Feb. 24, 2022

(54) METHOD FOR CONNECTING TO NETWORK AND ELECTRONIC DEVICE PERFORMING SAME

(71) Applicant: Samsung Electronics Co., Ltd., Gyeonggi-do (KR)

(72) Inventors: Yungyu BAE, Gyeonggi-do (KR); Kicheol NAM, Gyeonggi-do (KR)

(21) Appl. No.: 17/275,728

(22) PCT Filed: Aug. 30, 2019
(86) PCT No.: PCT/KR2019/011144

§ 371 Date: Mar. 12, 2021

(30) Foreign Application Priority Data
Sep. 20, 2018 (KR) 10-2018-0112589

(51) Int. Cl. H04W 76/38; H04W 36/00

(52) U.S. Cl. CPC H04W 76/38; H04W 36/0079

(57) ABSTRACT

Disclosed is an electronic device comprising: a communication module connected to an antenna capable of transmitting or receiving a signal via at least one network; and a processor electrically connected to the communication module. The processor may be configured to: in order to transmit data, transmit a signal for requesting a connection to a first network to a first base station by means of the communication module; receive a first signal, which includes timer information and is for rejecting the connection to the first network, from the first base station by means of the communication module; and if the data is of a specified type, transmit a signal for requesting a connection to a second network to a second base station before expiration of a time based on the timer information by means of the communication module. Various other embodiments understood via the specification are also possible.

### TECHNICAL FIELD

Embodiments disclosed in the present disclosure relate to a method for connecting to a network and an electronic device performing the same.

### BACKGROUND ART

With the development of information technology (IT), various types of electronic devices such as a smartphone and a tablet personal computer (PC) have been widely spread. The electronic devices may communicate with other electronic devices by connecting to a network provided by a base station.

Each base station may have a range, a so-called cell, capable of providing a network connection to an electronic device. The ranges may overlap each other, and accordingly, there may be a plurality of networks that is able to be used by one electronic device. In this case, the electronic device may search for a network having the highest priority among the plurality of networks. For example, when a smartphone is powered on, it may search for nearby cellular networks and access available carrier networks.

### DISCLOSURE OF THE INVENTION

### Technical Problem

Each network may have a limited resource block (RB). For example, for a broadband network, a sufficient number of resource blocks may be provided; in contrast, for a narrowband network, for example, the narrowband-internet of things (NB-IOT), only a very limited number of resource blocks may be provided. As described above, when a plurality of electronic devices simultaneously attempts to access the network having a limited number of resource blocks, access to an electronic device having a low priority, for example, an electronic device from which access request arrives relatively late may be delayed.

The access delay may occur without considering the urgency or importance of an operation intended to be performed by the electronic device. For example, a first electronic device may attempt to perform an operation with a relatively low urgency, and a second electronic device may attempt to perform an operation with relatively high urgency. Since the base station providing the network does not know the information on the urgency or importance, when the access request from the first electronic device is made first, the second electronic device may not access the network for a specified time (for example, up to 30 minutes) and thus, the operation with relatively high urgency may not be performed.

The embodiments disclosed in the present disclosure are to provide an electronic device capable of performing efficient network access based on data types.

### Technical Solution

According to an aspect of the present disclosure, there is provided an electronic device including a communication module connected to an antenna capable of transmitting or receiving a signal via at least one network, and a processor electrically connected to the communication module, in which the processor is configured to transmit a signal for requesting a connection to a first network to a first base station by using the communication module in order to transmit data, receive a first signal including timer information and rejecting the connection to the first network from the first base station by using the communication module, and transmit a signal for requesting a connection to the second network to a second network by using the communication module before a time based on the timer information expires, if the data is of a specified type.

According to another aspect of the present disclosure, there is provided a method for connecting to a network including transmitting a signal for requesting a connection to a first network to a first base station in order to transmit data, receiving a first signal including timer information and rejecting the connection to the first network from the first base station, and transmitting a signal for requesting a connection to the second network to a second base station before a time based on the timer information expires, if the data is of a specified type.

According to still another aspect of the present disclosure, there is provided a computer-readable storage medium storing instructions that are executable by a processor, the instructions, when executed, causing the processor of an electronic device to transmit a signal for requesting a connection to a first network to a first base station by using a communication module of the electronic device in order to transmit data, receive a first signal including timer information and rejecting the connection to the first network from the first base station by using the communication module, and transmit a signal for requesting a connection to the second network to a second base station by using the communication module before a time based on the timer information expires if the data is of a specified type.

### Advantageous Effects

According to the embodiments disclosed in the present disclosure, when attempting to perform an operation having relatively high urgency or importance, an electronic device may access a network and perform the operation within a relatively faster time.

According to the embodiments disclosed in the present disclosure, the electronic device may increase utilization and efficiency of a plurality of networks. Besides, various effects may be provided that are directly or indirectly identified through the present disclosure.

### BRIEF DESCRIPTION OF THE DRAWINGS

FIG. 1 illustrates a network environment including an electronic device, according to an embodiment of the present disclosure.

FIG. 2a is a signal flow diagram of a network connection method of an electronic device according to various embodiments of the present disclosure.

FIG. 2b is a signal flow diagram of a network connection method of an electronic device according to various embodiments of the present disclosure.

FIG. 3 is a flowchart illustrating a method for connecting to a network when an electronic device provides an emergency service, according to an embodiment of the present disclosure.

FIG. 4 is a flowchart illustrating a method for connecting to a network when an electronic device provides an emergency service, according to another embodiment of the present disclosure.

FIG. 5 is a flowchart illustrating a method for connecting to a network when an electronic device provides an emergency service, according to yet another embodiment of the present disclosure.

FIG. 6 is a block diagram illustrating an electronic device in a network environment, according to various embodiments of the present disclosure.

With respect to the description of the drawings, the same or similar reference signs may be used for the same or similar elements.

### MODE FOR CARRYING OUT THE INVENTION

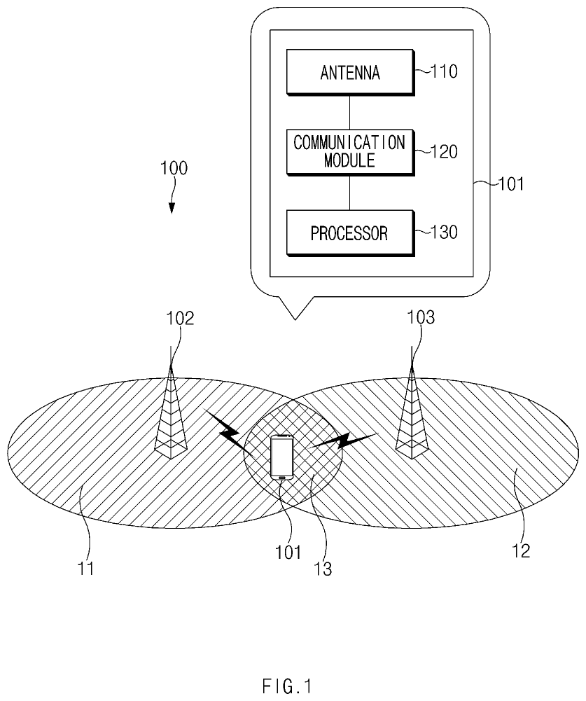

FIG. 1 illustrates a network environment 100 including an electronic device, according to an embodiment of the present disclosure.

Referring to FIG. 1, an electronic device 101 may use a plurality of networks provided from a plurality of base stations within the network environment 100. For example, the electronic device 101 may use a first network provided by a first base station 102 and a second network provided by a second base station 103. According to various embodiments of the present disclosure, unlike FIG. 1, the electronic device 101 may use a third network provided by a third base station. According to an embodiment of the present disclosure, the electronic device 101 may have a different distance from each base station. For example, as illustrated in FIG. 1, the electronic device 101 may be closer to the first base station 102 than the second base station 103.

According to an embodiment of the present disclosure, each base station may be associated with at least one cell. For example, the electronic device 101 may access the first network through a first cell of the first base station 102. For example, the coverage of the first cell may correspond to a first area 11. For another example, the electronic device 101 may access the second network through a second cell of the second base station 103. For example, the coverage of the second cell may correspond to a second area 12.

According to an embodiment of the present disclosure, even if the first cell and the second cell are geographically established not to overlap each other, the coverage of the first cell and the coverage of the second cell may overlap each other at the boundary as illustrated in FIG. 1. For example, a third area 13 may be an area where the first area 11 and the second area 12 overlap each other. For example, when the electronic device 101 is located in the third area 13, the electronic device 101 may have accessibility to both the first cell of the first base station 102 and the second cell of the second base station 103.

According to various embodiments of the present disclosure, a cell associated with each base station may have radio resources corresponding to the number of resource blocks of a specified size. For example, the number of resource blocks allocated to each of the first cell and the second cell may be different from each other. According to an embodiment of the present disclosure, the amount of radio resources (e.g., the number of resource blocks) allocated to each cell may be different depending on the type of service associated with the cell. For example, if the first network associated with the first cell or the second network associated with the second cell is a network that supports NB-IoT, a relatively small amount of radio resources (e.g., 1 resource block) may be allocated to the first cell or the second cell. As the amount of available radio resources decreases, the number of electronic devices that are possible to simultaneously access a corresponding cell may decrease. For example, the number of electronic devices that are possible to simultaneously access cells associated with the NB-IoT network may be limited to a specified number.

According to an embodiment of the present disclosure, the electronic device 101 may have a specified priority for available networks. For example, in attempting to access a network, the electronic device 101 may attempt to access a network according to a specified priority. In an embodiment of the present disclosure, the priority may be determined based on at least one of a data transmission rate, a distance to a base station, a channel quality (e.g., signal reception power), a latency, a radio access technology (RAT), or reliability. In an embodiment of the present disclosure, among the first network provided by the first base station 102 and the second network provided by the second base station 103, a network of higher network quality which is to be provided to the electronic device 101 may have a higher priority. For example, among the first network and the second network, the first network having a closer distance from the electronic device 101 may have a higher priority than the second network. For another example, the received power of the received signal from the first base station 102 associated with the first network may be higher than the received power of the received signal from the second base station 103 associated with the second network. For another example, the RAT of the first network may correspond to a higher priority than the RAT of the second network. In this case, the electronic device 101 may request a connection to the first network before that to the second network.

According to an embodiment of the present disclosure, when the electronic device 101 requests connection to the first network, the first base station 102 may allow or restrict the access of the electronic device 101. For example, when the request for connection to the first network is received from the electronic device 101, the first base station 102 may allow or restrict the access of the electronic device 101 based on the availability of radio resources associated with the first network. For another example, when the electronic device 101 does not satisfy a specified condition for connection to the first network, the first base station 102 may restrict the access of the electronic device 101 to the first network.

According to an embodiment of the present disclosure, when the first base station 102 restricts the access of the electronic device 101, the first base station 102 may transmit a specified signal including timer information to the electronic device 101. For example, the first base station 102 may notify the electronic device 101 that the connection to the first network is restricted through the specified signal, and may set a wait time corresponding to the timer information for the electronic device 101.

According to an embodiment of the present disclosure, the electronic device 101 may include an antenna 110, a communication module 120, and a processor 130. According to various embodiments of the present disclosure, the electronic device 101 is not limited to that illustrated in FIG. 1, and may further include a component not illustrated. For example, the electronic device 101 may further include a memory electrically connected to the processor 130.

According to an embodiment of the present disclosure, the antenna 110 may transmit or receive a signal via at least one network. For example, the antenna 110 may transmit or receive a signal having a specified frequency band.

According to an embodiment of the present disclosure, the communication module 120 may be electrically connected to the antenna 110 and the processor 130. The communication module 120 may generate a signal of a specified frequency band and transmit the generated signal to an external device, for example, the first base station 102 or the second base station 103 via the antenna 110. For example, the communication module 120 may transmit a signal for requesting a connection to the first network or the second network by using the antenna 110. The communication module 120 may receive a signal of a specified frequency band from an external device, for example, the first base station 102 or the second base station 103 via the antenna 110. For example, the communication module 120 may receive a signal for allowing (e.g., radio resource control (RRC) connection establishment) or rejecting (e.g., RRC connection rejection) the connection to the first network or the second network from the first base station 102 or the second base station 103 by using the antenna 110.

According to an embodiment of the present disclosure, the communication module 120 may support at least one radio access technology (RAT). According to various embodiments of the present disclosure, the RAT may include at least one of 3G protocol, 4G protocol such as long term evolution (LTE), 5G protocol such as new radio (NR), or Wi-Fi protocol. According to an embodiment of the present disclosure, priority may be set between the at least one RAT. For example, if the communication module 120 supports 4G protocol, 5G protocol, and Wi-Fi protocol, the priority may be set in the order of Wi-Fi protocol, 5G protocol, and 4G protocol.

According to an embodiment of the present disclosure, the processor 130 may be electrically connected to components included in the electronic device 101 and may control operations of the components or perform specified operations on the components. For example, the processor 130 may perform a specified operation, for example, transmit specified data to another electronic device.

According to various embodiments of the present disclosure, the specified data may include emergency data, for example, data to be transmitted without delay within a specified time. For example, the specified data may include real-time information on the current location of the electronic device 101. For another example, the specified data may include information on an urgent state of the user (e.g., request for rescue). According to an embodiment of the present disclosure, the specified data may include at least one bit indicating that the corresponding data is emergency data.

According to an embodiment of the present disclosure, the processor 130 may determine whether the specified data is emergency data. For example, if the maximum allowable wait time for the specified data is less than or equal to a specified level, the processor 130 may determine that the specified data is emergency data. The maximum allowable wait time may be understood as, for example, a maximum allowable time during which the specified data is to be recognized as being validly transmitted to another electronic device via a network. For another example, the processor 130 may determine whether the specified data is emergency data based on whether the specified data is the same type as the type of emergency data stored in the memory. For another example, the processor 130 may determine whether data to be transmitted is emergency data based on the type of application (e.g., emergency or non-emergency) associated with the data.

According to an embodiment of the present disclosure, the processor 130 may request a connection to at least one network in order to transmit specified data. For example, the processor 130 may transmit a signal (e.g., RRC connection request) for requesting a connection to a network with the highest priority (e.g., the first network 210) by using the communication module 120. The network having the highest priority may include a network having the highest network quality, for example, at least one of a network located at the closest distance from the electronic device 101, a network having the best reception sensitivity, or a network having the shortest delay time. For another example, if the specified condition is satisfied, the processor 130 may transmit a signal for requesting a connection to a network with a second higher priority (e.g., the second network 220) by using the communication module 120.

According to an embodiment of the present disclosure, the processor 130 may receive a signal including a response to the request. For example, the processor 130 may receive, from the first base station 102, a signal for allowing (e.g., RRC connection establishment) or rejecting (e.g., RRC connection rejection) connection to the first network 210, by using the communication module 120. For another example, the processor 130 may receive, from the second base station 103, a signal for allowing or rejecting the connection to the second network 220, by using the communication module 120.

According to an embodiment of the present disclosure, the electronic device 101 may further include a memory electrically connected to the processor 130. Specified instructions or reference data for the operation of the processor 130 may be stored in the memory. For example, a maximum allowable wait time for each data that is able to be transmitted by the processor 130 may be stored in the memory. According to an embodiment of the present disclosure, information on the type or list of emergency data among data that is able to be transmitted by the processor 130 may be stored in the memory. For example, a list of applications (e.g., an application identifier list) associated with emergency data may be stored in the memory. For example, information on the maximum allowable wait time set in the application may be stored in the memory. According to an embodiment of the present disclosure, information on the maximum wait time set for each application may be different from each other.

According to various embodiments of the present disclosure, there may be cases where it is required to access the network within a time faster than the time corresponding to the timer information. For example, the electronic device 101 may perform an operation of transmitting the current location to the other electronic device 101 in real-time. For another example, the electronic device 101 may perform an operation of transmitting an emergency situation to another electronic device. In this case, it may be more advantageous for the electronic device 101 to attempt to connect to the second network having a relatively lower network quality than to wait for connection to the first network. Hereinafter, in the present specification, a method for performing a specified operation through access to the second network when the electronic device 101 to which access to the first network according to various embodiments of the present disclosure is restricted satisfies a specified condition will be described.

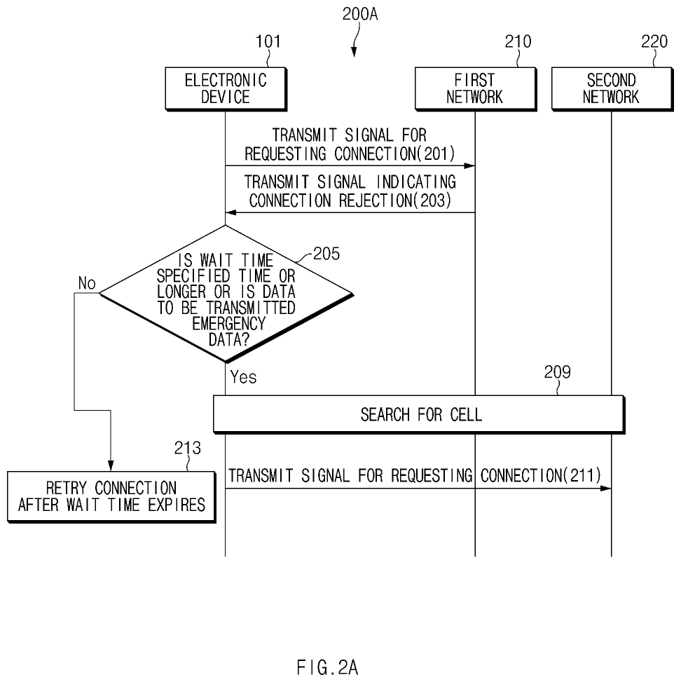

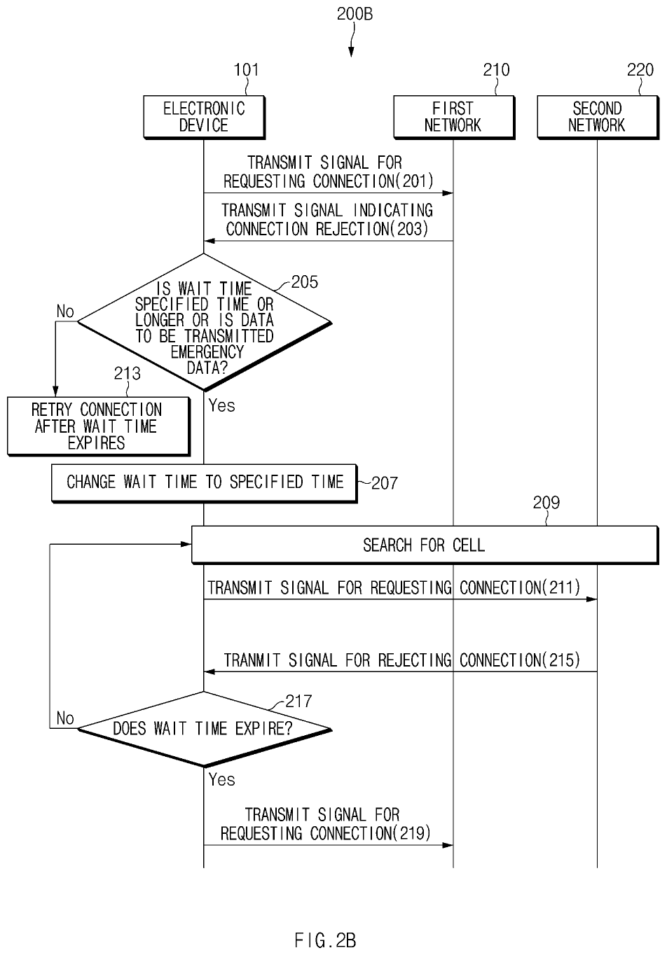

FIG. 2a is a signal flow diagram 200A of a network connection method of the electronic device 101 according to various embodiments of the present disclosure.

Referring to FIG. 2a, the first network 210 may be a network associated with a first base station (e.g., the first base station 102 of FIG. 1). For example, the first network 210 may be a network associated with a serving cell of the electronic device 101. For example, the second network 220 may be a network associated with a second base station (e.g., the second base station 103 of FIG. 1). For example, the second network 210 may be a network associated with a neighboring cell of the serving cell of the electronic device 101. For example, the electronic device 101 may be a device supporting a delay tolerant connection. For example, the electronic device 101 may be a device supporting NB IoT.

According to various embodiments of the present disclosure, in operation 201, the electronic device 101 may transmit a signal for requesting a connection to the first network 210. For example, the electronic device 101 may transmit a radio resource control (RRC) connection request. According to an embodiment of the present disclosure, the RRC connection request may include information indicating that the electronic device 101 is an NB IoT device. For example, the RRC connection request may include information indicating that the connection request is an NB IoT connection. According to an embodiment of the present disclosure, the RRC connection request may include information indicating that the connection request is delay tolerant. For example, the RRC connection request including information indicating delay tolerance may indicate that the connection request is a connection request that is not sensitive to delay (e.g., allows a relatively high delay).

According to various embodiments of the present disclosure, in operation 203, the first network 210 may transmit a signal indicating connection rejection to the electronic device 101. For example, the first network 210 may transmit a signal including an RRC connection rejection to the electronic device 101. For example, the first network 210 may transmit an RRC connection rejection due to a temporary failure or congestion of the network. For example, when the first network 210 is an NB-IoT network, a congestion situation may occur frequently since the amount of radio resources of the first network 210 may be limited.

According to various embodiments of the present disclosure, the first network 210 may transmit the RRC connection rejection in which information indicating access restriction of the electronic device 101 is included. For example, the RRC connection rejection may include information indicating the backoff of the electronic device 101 for a predetermined time. According to an embodiment of the present disclosure, the first network 210 may set a backoff time in the electronic device 101 by including extended wait time information in the RRC connection rejection. For example, the extended wait time may mean a time for restricting the electronic device 101 from attempting to access the network (e.g., transmitting the RRC connection request) for the specified extended wait time. According to an embodiment of the present disclosure, the first network 210 may set a deprioritization request to reject an RRC connection to set a backoff time for the electronic device 101. For example, the deprioritization request may include information on frequency band or information on RAT, for which deprioritization is requested. The deprioritization request may include timer information (e.g., 5 minutes, 10 minutes, 15 minutes, or 30 minutes) for which deprioritization is requested. For example, the deprioritization request may be used to set a backoff for a requested time (e.g., timer information) for a requested frequency band and/or RAT in the electronic device 101.

If the electronic device 101 supports the delay tolerant access and receives the RRC connection rejection including the extended wait time information, the electronic device 101 may be configured to transmit the received extended wait time information to a higher layer (e.g., the higher layer of the RRC layer) and not attempt to access for the specified extended wait time.

If the electronic device 101 supports deprioritization and receives the RRC connection rejection including the deprioritization request, the electronic device 101 may restart a specified timer (e.g., T325) and may set the timer value according to the deprioritization time information indicated by the deprioritization request. Furthermore, the electronic device 101 may store the deprioritization request until the specified timer expires.

Therefore, if the electronic device 101 performs the backoff operation based on the RRC connection rejection, the electronic device 101 may not attempt to access the network for a specified time. However, in the step of requesting a connection to the network, since the network may not know whether the data to be transmitted by the electronic device 101 is emergency data or not, emergency data may be delayed for a long time when the RRC connection rejection is received. For example, both the deprioritization request and the extended wait time may be set up to 30 minutes. In this case, the electronic device 101 may not access the network for the indicated time by the RRC connection rejection. Accordingly, emergency data of the electronic device 101 may not be transmitted.

According to an embodiment of the present disclosure, the electronic device 101 may be a device for transmitting a rescue signal. The electronic device 101 may be a device that simply transmits a rescue signal, and may transmit a rescue signal including a signal including location information of the electronic device 101. For example, the electronic device 101 requires only a relatively small amount of data to be transmitted and received, and thus may be an NB IoT device having a delay tolerance property. In this case, despite the urgency of data transmitted by the electronic device 101, the electronic device 101 may not be able to transmit the rescue signal for a considerable time due to the backoff set by the network. Accordingly, according to an operation to be described later in connection with operations 205 to 213 below, the electronic device 101 may prevent a transmission delay of the emergency data.

According to various embodiments of the present disclosure, in operation 205, the electronic device 101 may determine whether the wait time set by the network is equal to or greater than a specified time or whether data to be transmitted is emergency data. According to an embodiment of the present disclosure, the electronic device 101 may determine whether the extended wait time or the deprioritization timer time included in the RRC connection rejection is equal to or greater than a specified time.

According to an embodiment of the present disclosure, the specified time may be a data guard time set in the electronic device 101. For example, the data guard time may be a fixed time or a time set based on the type of application to which data is to be transmitted (e.g., emergency application or non-emergency application). For another example, the data guard time may be a time set based on the type of data to be transmitted (e.g., emergency data). For example, the data guard time may be a value corresponding to the maximum delay time that the data to be transmitted is able to allow.

According to an embodiment of the present disclosure, the electronic device 101 may determine whether data to be transmitted is emergency data. For example, the electronic device 101 may determine whether data to be transmitted is emergency data by using information on the type of application (e.g., emergency application and non-emergency application). For another example, the electronic device 101 may determine whether data to be transmitted is emergency data based on information set for each application. For still another example, the electronic device 101 may determine whether data to be transmitted is emergency data based on at least one specified bit of data to be transmitted. The emergency data may be set to indicate that at least one specified bit (e.g., a flag) is emergency data.

According to various embodiments of the present disclosure, in operation 209, the electronic device 101 may perform a cell search if the wait time is longer than a specified time or data to be transmitted is emergency data. For example, in performing a cell search, the electronic device 101 may perform the cell search except the first network 210 that has transmitted a signal indicating connection rejection. For example, the electronic device 101 may select the second network 220 as a result of the cell search.

According to various embodiments of the present disclosure, in operation 211, the electronic device 101 may transmit a signal for requesting a connection to the second network 220 based on the result of the cell search. For example, the electronic device 101 may transmit the RRC connection request to the second network 220.

According to various embodiments of the present disclosure, in operation 213, the electronic device 101 may retry the connection after the wait time indicated by the RRC connection rejection expires if the wait time is less than the specified time and the data to be transmitted is general data (e.g., non-emergency data). For example, the electronic device 101 may retransmit the RRC connection request to the first network 210.

FIG. 2b is a signal flow diagram 200B of a network connection method of an electronic device according to various embodiments of the present disclosure.

With reference to FIG. 2b, descriptions of operations having the same reference numerals as in FIG. 2a may be referred to by descriptions related to FIG. 2a. In the embodiment of FIG. 2b, the electronic device 101 may perform some different operation from the embodiment of FIG. 2a if the wait time is longer than a specified time or data to be transmitted is emergency data.

According to various embodiments of the present disclosure, in operation 207, the electronic device 101 may change the wait time to a specified time if the wait time is the specified time or longer, or data to be transmitted is emergency data, or if the wait time (e.g., extended wait time or deprioritization timer time) indicated by the signal indicating connection rejection (e.g., RRC connection rejection) is the specified time (e.g., data guard time) or longer.

According to various embodiments of the present disclosure, in operation 209, the electronic device 101 may perform a cell search. For example, the electronic device 101 may transmit a signal for requesting a connection (e.g., the RRC connection request) to the second network 220 (e.g., operation 211) if the electronic device 101 discovers the second network 220 through the cell search. According to an embodiment of the present disclosure, the second network 220 may also transmit a signal indicating connection rejection (e.g., RRC connection rejection) to the electronic device 101 (e.g., operation 215). Accordingly, the electronic device 101 may fail to connect to the second network 220. For another example, the electronic device 101 may not be able to discover another network (e.g., the second network 220) through the cell search.

In this case, according to various embodiments of the present disclosure, the electronic device 101 may determine whether the wait time expires (e.g., operation 217), and may transmit the signal for requesting the connection to the first network 210 when the waiting time expires (e.g., operation 219). Therefore, by changing the wait time to the specified time in operation 207, the electronic device 101 may retry the connection to the first network 210 after the wait time reduced to the specified time if the access to another network fails (including a discovery failure of another network).

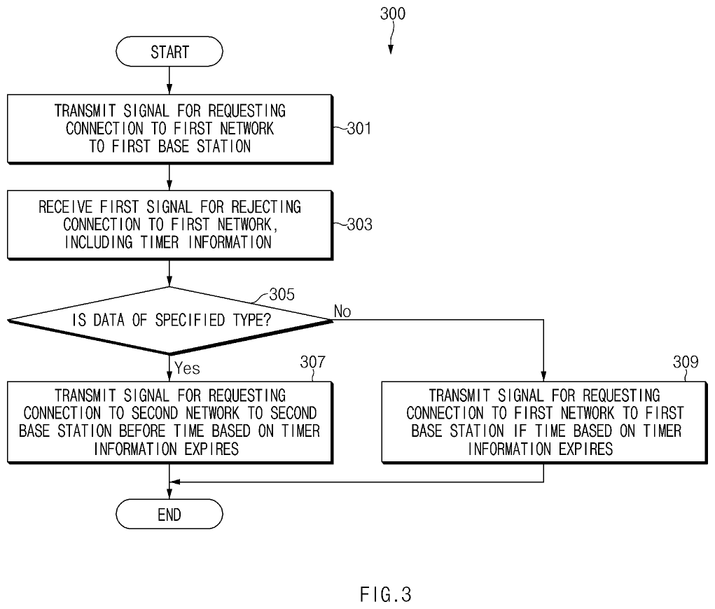

FIG. 3 is a flowchart illustrating a method 300 for connecting to a network when an electronic device provides an emergency service, according to an embodiment of the present disclosure.

Referring to FIG. 3, the method 300 for connecting to a network, which is performed by the electronic device, may include operations 301 to 309. According to an embodiment of the present disclosure, the operations 301 to 309 may be understood as being performed by the electronic device 101 (or the processor 130) illustrated in FIG. 2.

According to various embodiments of the present disclosure, in operation 301, the electronic device 101 may transmit a signal for requesting a connection to a first network (e.g., the first network 210 of FIG. 2a) to a first base station (e.g., the first base station 102 of FIG. 1) in order to transmit specified data. In an embodiment of the present disclosure, the electronic device may transmit the signal via an antenna (e.g., the antenna 110 of FIG. 1) by using a communication module (e.g., the communication module 120 of FIG. 1). According to an embodiment of the present disclosure, the first network may be a network with a highest priority among at least one network that is connectable by an electronic device.

According to various embodiments of the present disclosure, in operation 303, the electronic device 101 may receive, from the first base station, a first signal (e.g., RRC connection rejection) for rejecting the connection to the first network. For example, if a plurality of other electronic devices are already connected to the first network and there is no more resource block available in the first network, the first base station may transmit the first signal for rejecting the connection of the electronic device to the first network.

According to an embodiment of the present disclosure, the first base station may include specified timer information in the first signal. For example, the timer information may be a request wait time set by the first base station. For example, the timer information may include deprioritization timer information or extended wait time information. The request wait time (e.g., extended wait time information) may be understood as a time set by the first base station for the electronic device 101 not to attempt to connect to the first network. For another example, the timer information (e.g., deprioritization timer information) may be a RAT priority change time set by the first base station for the electronic device 101. The RAT priority change time may be a time set by the first base station to change the priority of the RAT specified for the electronic device to, for example, the lowest priority and maintain the changed priority.

In various embodiments of the present disclosure, the electronic device 101 may attempt to access a network before expiration of a time specified by the timer information, for example, the request wait time or the RAT priority change time. For example, the electronic device 101 may attempt to access a network before expiration of a time specified by timer information based on a type of data to be transmitted or a maximum delay time of data to be transmitted.

According to various embodiments of the present disclosure, in operation 305, the electronic device 101 may determine whether the specified data to be transmitted is of a specified type (e.g., emergency data). If the specified data corresponds to the specified type, the electronic device may perform operation 307, and if the specified data does not correspond to the specified type, the electronic device may perform operation 309.

According to an embodiment of the present disclosure, the specified type of data may be understood as emergency data. The emergency data may include, for example, data to be transmitted without delay within a specified time. For example, the emergency data may be a rescue signal. For example, the rescue signal may include real-time information on the current location of the electronic device 101. For another example, the emergency data may include information on an urgent state of the user. For example, the emergency data may include information indicating that the user of the electronic device 101 is currently in danger.

According to an embodiment of the present disclosure, the electronic device 101 may determine whether the specified data is of the specified type based on the maximum allowable wait time for the specified data. For example, if the maximum allowable wait time is shorter than a time corresponding to the timer information, the electronic device 101 may determine that the specified data is emergency data. According to another embodiment of the present disclosure, the electronic device 101 may determine whether the specified data is of the specified type based on data stored in the memory. For example, if the specified data corresponds to a type of emergency data stored in a memory, the electronic device may determine that the specified data is emergency data. According to another embodiment of the present disclosure, the electronic device 101 may determine whether the specified data is emergency data based on a flag included in the specified data. According to another embodiment of the present disclosure, the electronic device 101 may determine whether the specified data is emergency data based on the type of application associated with the data to be transmitted.

According to various embodiments of the present disclosure, in operation 307, the electronic device 101 may transmit a signal for requesting a connection to the second network to the second base station, before the time based on the timer information included in the first signal expires. In an embodiment of the present disclosure, the electronic device may request the connection to the second network in response to the received first signal. Since the specified data corresponds to a specified type, for example, emergency data, the electronic device may request a connection to a network other than the first network, for example, a second network with a lower priority than the first network. If the electronic device is connected to the second network, the electronic device may transmit specified data to another electronic device via the second network.

According to various embodiments of the present disclosure, in operation 309, the electronic device 101 may wait until the time based on timer information included in the first signal expires. For example, since the specified data does not correspond to a specified type, for example, emergency data, the electronic device 101 may not request the connection to the network other than the first network, for example, the second network with a lower priority than the first network. If the time expires, the electronic device 101 may transmit the signal for requesting the connection to the first network to the first base station. If the electronic device is connected to the first network, the electronic device may transmit specified data to another electronic device via the first network.

Through operations 301 to 309 according to various embodiments of the present disclosure, the electronic device may determine the type of data to be transmitted and may additionally request a connection to the next priority network only when the data is emergency data. In this way, the electronic device may effectively transmit emergency data.

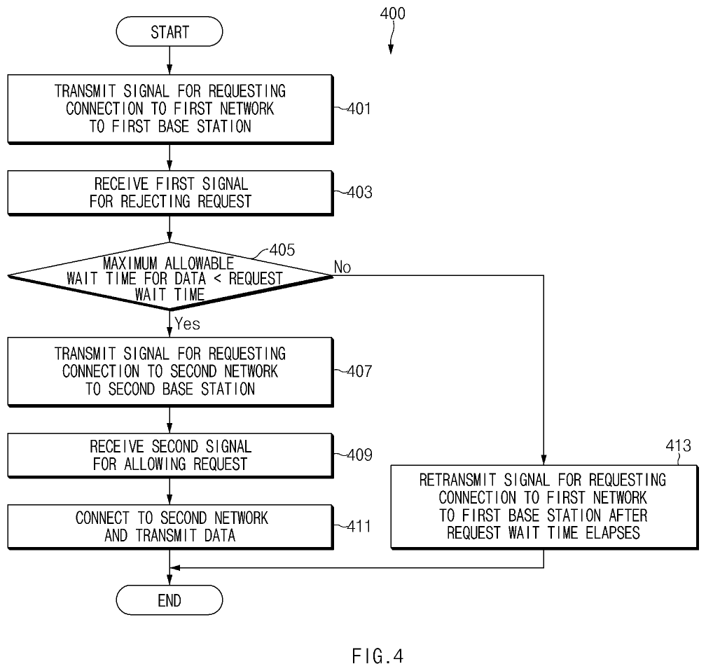

FIG. 4 is a flowchart illustrating a method 400 for connecting to a network when the electronic device 101 provides an emergency service, according to another embodiment of the present disclosure.

Referring to FIG. 4, the method 400 for connecting to a network, which is performed by the electronic device, may include operations 401 to 413. According to an embodiment of the present disclosure, the operations 401 to 413 may be understood as being performed by the electronic device 101 (or the processor 130) illustrated in FIG. 2. In the description of FIG. 4, content that has been already shown in the description of FIG. 3 may be omitted. For example, descriptions of operations 401 to 403 may be the same as or similar to descriptions of operations 301 to 303 illustrated in FIG. 3.

In operation 401, the electronic device may transmit a signal for requesting a connection to a first network (e.g., the first network 210 of FIG. 2) (e.g., RRC connection request) to a base station (e.g., the first base station 102 of FIG. 2) in order to transmit specified data.

In operation 403, the electronic device may receive, from the first base station, a first signal (e.g., RRC connection rejection) for rejecting the connection to the first network. In an embodiment of the present disclosure, the first signal may include timer information (e.g., extended wait time or deprioritization timer). For example, the timer information may be a request wait time set by the first base station. The request wait time may be understood as a time set by the first base station for the electronic device not to attempt to connect to the first network.

According to various embodiments of the present disclosure, in operation 405, the electronic device may determine whether the maximum allowable wait time for data to be transmitted is shorter than the time corresponding to the timer information included in the first signal received in operation 403, for example, the request wait time. In an embodiment of the present disclosure, if the maximum allowable wait time for the data is shorter than the request wait time, the electronic device may determine that the data is emergency data and may perform operation 407. In an embodiment of the present disclosure, if the maximum allowable wait time for the data is longer than the request wait time, the electronic device may determine that the data is not emergency data and may perform operation 413.

According to an embodiment of the present disclosure, the maximum allowable wait time for the data may be different depending on the type of the data. In an embodiment of the present disclosure, the maximum allowable wait time may be stored in the memory. In various embodiments of the present disclosure, operation 405 may be understood as an operation corresponding to operation 305 illustrated in FIG. 3.

In operation 407, the electronic device may transmit, to the second base station, a signal for requesting a connection to a network with a lower priority than the first network, for example, the second network. According to an embodiment of the present disclosure, the electronic device may perform the operation 407 before the request wait time expires, for example, in response to the received first signal. According to various embodiments of the present disclosure, operation 407 may be understood as an operation corresponding to operation 307 illustrated in FIG. 3.

According to various embodiments of the present disclosure, in operation 409, the electronic device may receive, from the second base station, a second signal for allowing the connection to the second network.

According to various embodiments of the present disclosure, in operation 411, the electronic device may connect to the second network and may transmit specified data, for example, emergency data, to another electronic device via the second network.

According to various embodiments of the present disclosure, in operation 413, the electronic device may request the connection to the first network again after the request wait time elapses. For example, after waiting for the request wait time, the electronic device may retransmit the signal for requesting the connection to the first network to the first network.

Through operations 401 to 413 according to various embodiments of the present disclosure, the electronic device may determine the type of data to be transmitted and may additionally request a connection to the next priority network only when the data is emergency data. In this way, the electronic device may effectively transmit emergency data.

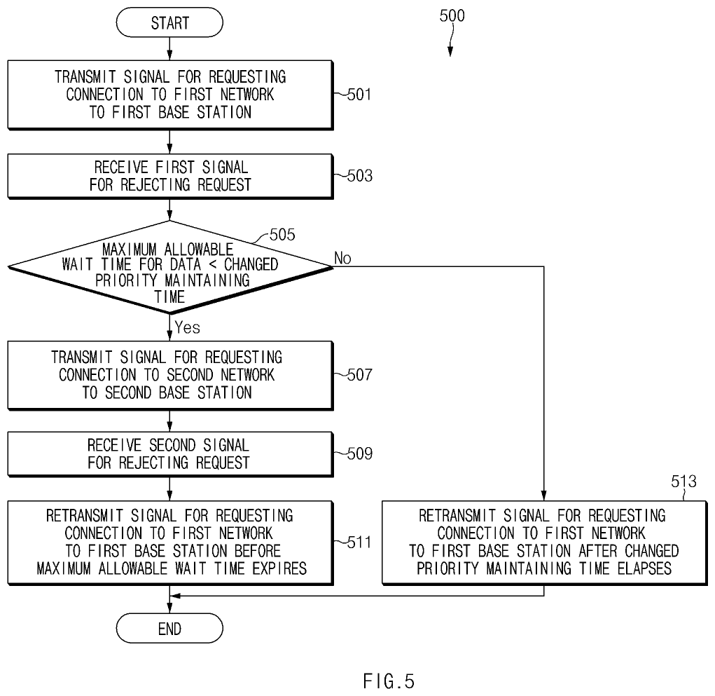

FIG. 5 is a flowchart illustrating a method 500 for connecting to a network when the electronic device 101 provides an emergency service, according to yet another embodiment of the present disclosure.

Referring to FIG. 5, the method 500 for connecting to a network, which is performed by the electronic device, may include operations 501 to 513. According to an embodiment of the present disclosure, the operations 501 to 513 may be understood as being performed by the electronic device 101 (or the processor 130) illustrated in FIG. 2. In the description of FIG. 5, content that has been already shown in the descriptions of FIG. 3 or FIG. 4 may be omitted. For example, descriptions of operations 501 to 503 may be the same as or similar to descriptions of operations 301 to 303 illustrated in FIG. 3, or descriptions of operations 401 to 403 illustrated in FIG. 4. For another example, the description of operation 507 may be the same as or similar to the description of operation 407 illustrated in FIG. 4.

According to various embodiments of the present disclosure, in operation 501, the electronic device may transmit a signal for requesting a connection to a first network (e.g., the first network 210 of FIG. 2) (e.g., RRC connection request) to a first base station (e.g., the first base station 102 of FIG. 2) in order to transmit specified data.

According to various embodiments of the present disclosure, in operation 503, the electronic device may receive, from the first base station, a first signal (e.g., RRC connection rejection) for rejecting the connection to the first network. In an embodiment of the present disclosure, the first signal may include timer information. For example, the timer information may be a RAT priority change time set by the first base station. The RAT priority change time may be a time set by the first base station to change the priority of the RAT specified for the electronic device to, for example, the lowest priority and maintain the changed priority.

According to an embodiment of the present disclosure, the electronic device may support a single RAT. In this case, changing the priority of the single RAT to the lowest priority, during a specified time, for example, a priority change time, may be understood similarly to limiting network connection using the RAT during the specified time.

According to various embodiments of the present disclosure, in operation 505, the electronic device may determine whether the maximum allowable wait time for data to be transmitted is shorter than the time corresponding to the timer information included in the first signal received in operation 403, for example, the priority change time. In an embodiment of the present disclosure, if the maximum allowable wait time for the data is shorter than the priority change time, the electronic device may determine that the data is emergency data and may perform operation 407. In an embodiment of the present disclosure, if the maximum allowable wait time for the data is longer than the priority change time, the electronic device may determine that the data is not emergency data and may perform operation 413.

According to various embodiments of the present disclosure, the maximum allowable wait time for the data may be different depending on the type of the data. In an embodiment of the present disclosure, the maximum allowable wait time may be stored in the memory. In various embodiments of the present disclosure, operation 505 may be understood as an operation corresponding to operation 305 illustrated in FIG. 3.

According to various embodiments of the present disclosure, in operation 507, the electronic device may transmit, to the second base station, a signal for requesting a connection to a network with a lower priority than the first network, for example, the second network.

According to various embodiments of the present disclosure, in operation 509, the electronic device may receive, from the second base station, a second signal for rejecting the connection to the second network. For example, if there is no resource block available in the second network, the second base station may reject the connection to the second network.

According to various embodiments of the present disclosure, in operation 511, the electronic device may retransmit the signal for requesting the connection to the first network to the first base station before expiration of the maximum allowable wait time for data. Even before the time corresponding to the timing information included in the first signal received in operation 503 elapses, since the resource block status of the first network may be changed, the electronic device may request the connection to the first network again. If the electronic device is connected to the first network, the electronic device may transmit data to another electronic device via the first network.

According to various embodiments of the present disclosure, in operation 513, the electronic device may request the connection to the first network again after the priority change time elapses. For example, after waiting for the priority change time, the electronic device may retransmit the signal for requesting the connection to the first network to the first network.

Through operations 501 to 513 according to various embodiments of the present disclosure, the electronic device may determine the type of data to be transmitted and may additionally request a connection to the next priority network only when the data is emergency data. In this way, the electronic device may effectively transmit emergency data.

According to an embodiment, an electronic device may include a communication module connected to an antenna capable of transmitting or receiving a signal via at least one network, and a processor electrically connected to the communication module, and the processor may be configured to transmit a signal for requesting a connection to a first network to a first base station by using the communication module in order to transmit data, receive a first signal including timer information and rejecting the connection to the first network from the first base station by using the communication module, and transmit a signal for requesting a connection to the second network to a second network by using the communication module before a time based on the timer information expires if the data is of a specified type.

According to an embodiment of the present disclosure, the processor may be configured to transmit the signal for requesting the connection to the second network to the second base station by using the communication module in response to the received first signal before the time based on the timer information expires, if the data is of the specified type.

According to an embodiment of the present disclosure, the processor may be configured to connect to the second network to transmit the data if a second signal for allowing the connection to the second network is received from the second base station by using the communication module.

According to an embodiment of the present disclosure, the processor may be configured to retransmit the signal for requesting the connection to the first network to the first base station before a maximum allowable wait time for the data at least elapses, if a third signal for rejecting the connection to the second network is received from the second base station by using the communication module.

According to an embodiment of the present disclosure, the data may correspond to the specified type if a maximum allowable wait time for the data is shorter than the time based on the timer information.

According to an embodiment of the present disclosure, the electronic device may further include a memory electrically connected to the processor and having information on the specified type stored therein, and the processor may be configured to determine whether the data corresponds to the specified type based on the information stored in the memory.

According to an embodiment of the present disclosure, the timer information may include a wait time for the first network.

According to an embodiment of the present disclosure, the communication module may support a single radio access technology (RAT), and the timer information may include a specified time for keeping a priority for the single RAT at the lowest.

According to an embodiment of the present disclosure, a method for connecting to a network may include transmitting a signal for requesting a connection to a first network to a first base station in order to transmit data, receiving a first signal including timer information and rejecting the connection to the first network from the first base station, and transmitting a signal for requesting a connection to the second network to a second base station before a time based on the timer information expires, if the data is of a specified type.

According to an embodiment of the present disclosure, the transmitting of the signal for requesting the connection to the second network may include transmitting the signal for requesting the connection to the second network to the second base station, in response to the received first signal.

According to an embodiment of the present disclosure, the method may further include receiving a second signal for allowing the connection to the second network from the second base station and connecting to the second network to transmit the data.

According to an embodiment of the present disclosure, the method may further include receiving a third signal for rejecting the connection to the second network from the second base station, and retransmitting the signal for requesting the connection to the first network to the first base station before a maximum allowable wait time for the data at least elapses.

According to an embodiment of the present disclosure, the method may further include comparing the maximum allowable wait time for the data and the time based on the timer information, and determining whether the data corresponds to the specified type based on the comparison result.

According to an embodiment of the present disclosure, the method may further include determining whether the data corresponds to the specified type based on information on the specified type stored in a memory.

According to an embodiment of the present disclosure, the timer information may include a wait time for the first network.

According to an embodiment of the present disclosure, the timer information may include a specified time for keeping a priority for a single RAT supported by a communication module at the lowest.

According to an embodiment of the present disclosure, a computer-readable storage medium may store instructions that are executable by a processor, and when executed, the instructions may cause the processor of an electronic device to transmit a signal for requesting a connection to a first network to a first base station by using a communication module of the electronic device in order to transmit data, receive a first signal including timer information and rejecting the connection to the first network from the first base station by using the communication module, and transmit a signal for requesting a connection to the second network to a second base station by using the communication module before a time based on the timer information expires if the data is of a specified type. According to the embodiments disclosed in the present disclosure, when attempting to perform an operation having relatively high urgency or importance, an electronic device may access a network and perform the operation within a relatively faster time. In addition, the electronic device may increase utilization and efficiency of a plurality of networks.

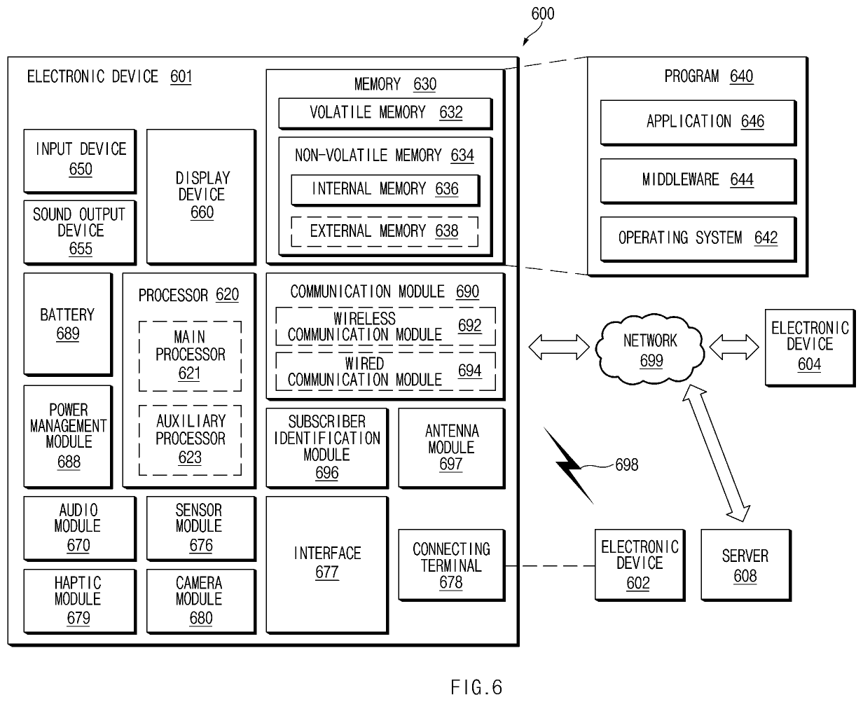

FIG. 6 is a block diagram illustrating an electronic device 601 in a network environment 600 according to various embodiments.

Referring to FIG. 6, the electronic device 601 in the network environment 600 may communicate with an electronic device 602 via a first network 698 (e.g., a short-range wireless communication network), or an electronic device 604 or a server 608 via a second network 699 (e.g., a long-range wireless communication network). According to an embodiment, the electronic device 601 may communicate with the electronic device 604 via the server 608. According to an embodiment, the electronic device 601 may include a processor 620, memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) 696, or an antenna module 697. In some embodiments, at least one (e.g., the display device 660 or the camera module 680) of the components may be omitted from the electronic device 601, or one or more other components may be added in the electronic device 601. In some embodiments, some of the components may be implemented as single integrated circuitry. For example, the sensor module 676 (e.g., a fingerprint sensor, an iris sensor, or an illuminance sensor) may be implemented as embedded in the display device 660 (e.g., a display).

The processor 620 may execute, for example, software (e.g., a program 640) to control at least one other component (e.g., a hardware or software component) of the electronic device 601 coupled with the processor 620, and may perform various data processing or computation. According to one embodiment, as at least part of the data processing or computation, the processor 620 may load a command or data received from another component (e.g., the sensor module 676 or the communication module 690) in volatile memory 632, process the command or the data stored in the volatile memory 632, and store resulting data in non-volatile memory 634. According to an embodiment, the processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or to be specific to a specified function. The auxiliary processor 623 may be implemented as separate from, or as part of the main processor 621.

The auxiliary processor 623 may control at least some of functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). According to an embodiment, the auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thererto. The memory 630 may include the volatile memory 632 or the non-volatile memory 634.

The program 640 may be stored in the memory 630 as software, and may include, for example, an operating system (OS) 642, middleware 644, or an application 646.

The input device 650 may receive a command or data to be used by other component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. According to an embodiment, the display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. According to an embodiment, the audio module 670 may obtain the sound via the input device 650, or output the sound via the sound output device 655 or a headphone of an external electronic device (e.g., an electronic device 602) directly (e.g., wiredly) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. According to an embodiment, the sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device (e.g., the electronic device 602) directly (e.g., wiredly) or wirelessly. According to an embodiment, the interface 677 may include, for example, a high definition multimedia interface (HDMI), a universal serial bus (USB) interface, a secure digital (SD) card interface, or an audio interface.

A connecting terminal 678 may include a connector via which the electronic device 601 may be physically connected with the external electronic device (e.g., the electronic device 602). According to an embodiment, the connecting terminal 678 may include, for example, a HDMI connector, a USB connector, a SD card connector, or an audio connector (e.g., a headphone connector),

The haptic module 679 may convert an electrical signal into a mechanical stimulus (e.g., a vibration or a movement) or electrical stimulus which may be recognized by a user via his tactile sensation or kinesthetic sensation. According to an embodiment, the haptic module 679 may include, for example, a motor, a piezoelectric element, or an electric stimulator.

The camera module 680 may capture a still image or moving images. According to an embodiment, the camera module 680 may include one or more lenses, image sensors, image signal processors, or flashes.

The power management module 688 may manage power supplied to the electronic device 601. According to one embodiment, the power management module 688 may be implemented as at least part of, for example, a power management integrated circuit (PMIC).

The battery 689 may supply power to at least one component of the electronic device 601. According to an embodiment, the battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the application processor (AP)) and supports a direct (e.g., wired) communication or a wireless communication. According to an embodiment, the communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as Bluetooth™, wireless-fidelity (Wi-Fi) direct, or infrared data association (IrDA)) or the second network 699 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. According to an embodiment, the antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 601 and the external electronic device 604 via the server 608 coupled with the second network 699. Each of the electronic devices 602 and 604 may be a device of a same type as, or a different type, from the electronic device 601. According to an embodiment, all or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 640) including one or more instructions that are stored in a storage medium (e.g., internal memory 636 or external memory 638) that is readable by a machine (e.g., the electronic device 601). For example, a processor (e.g., the processor 620) of the machine (e.g., the electronic device 601) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a communication module connected to an antenna to transmit or receive a signal via at least one network; and
a processor electrically connected to the communication module, wherein the processor is configured to:
transmit a signal for requesting a connection to a first network to a first base station using the communication module in order to transmit data,
receive a first signal including timer information and rejecting the connection to the first network from the first base station by using the communication module, and
transmit a signal for requesting a connection to the second network to a second base station by using the communication module before a time based on the timer information expires if the data is of a specified type.

2. The electronic device of claim 1, wherein the processor is configured to transmit the signal for requesting the connection to the second network to the second base station by using the communication module in response to the received first signal before the time based on the timer information expires, if the data is of the specified type.

3. The electronic device of claim 1, wherein the processor is configured to connect to the second network to transmit the data if a second signal for allowing the connection to the second network is received from the second base station by using the communication module.

4. The electronic device of claim 1, wherein the processor is configured to retransmit the signal for requesting the connection to the first network to the first base station before a maximum allowable wait time for the data at least elapses, if a third signal for rejecting the connection to the second network is received from the second base station by using the communication module.

5. The electronic device of claim 1, wherein the data corresponds to the specified type if a maximum allowable wait time for the data is shorter than the time based on the timer information.

6. The electronic device of claim 1, further comprising a memory electrically connected to the processor and having information on the specified type stored therein,
wherein the processor is configured to determine whether the data corresponds to the specified type based on the information stored in the memory.

7. The electronic device of claim 1, further comprising the timer information includes a wait time for the first network.

8. The electronic device of claim 1, wherein the communication module supports a single radio access technology (RAT), and
the timer information includes a specified time for keeping a priority for the single RAT at the lowest.

9. A method for connecting to a network, the method comprising:
transmitting a signal for requesting a connection to a first network to a first base station in order to transmit data;
receiving a first signal including timer information and rejecting the connection to the first network from the first base station; and
transmitting a signal for requesting a connection to the second network to a second base station before a time based on the timer information expires, if the data is of a specified type.

10. The method of claim 9, wherein the transmitting of the signal for requesting the connection to the second network to the second base station includes transmitting the signal for requesting the connection to the second network to the second base station, in response to the received first signal.

11. The method of claim 9, further comprising:
receiving a second signal for allowing the connection to the second network from the second base station; and
connecting to the second network to transmit the data.

12. The method of claim 9, further comprising:
receiving a third signal for rejecting the connection to the second network from the second base station; and
retransmitting the signal for requesting the connection to the first network to the first base station before a maximum allowable wait time for the data at least elapses.

13. The method of claim 9, further comprising:
comparing the maximum allowable wait time for the data and the time based on the timer information; and
determining whether the data corresponds to the specified type based on the comparison result.

14. The method of claim 9, further comprising determining whether the data corresponds to the specified type based on information on the specified type stored in a memory.

15. The method of claim 9, wherein the timer information includes a wait time for the first network.
